(19) United States
(12) Patent Application Publication
(10) Pub. No.: US 2015/0093545 A1
(43) Pub. Date: Apr. 2, 2015

(54) COMPOSITION FOR A SILICA BASED LAYER, SILICA BASED LAYER, AND METHOD OF MANUFACTURING A SILICA BASED LAYER

(71) Applicant: Samsung SDI Co., Ltd., Yongin-si (KR)

(72) Inventors: Kwen-Woo HAN, Suwon-si (KR); Taek-Soo KWAK, Suwon-si (KR); Bo-Sun KIM, Suwon-si (KR); Eun-Su PARK, Suwon-si (KR); Jin-Hee BAE, Suwon-si (KR); Jin-Woo SEO, Suwon-si (KR); Han-Song LEE, Suwon-si (KR); Wan-Hee LIM, Suwon-si (KR); Byeong-Gyu HWANG, Suwon-si (KR); Sang-Kyun KIM, Suwon-si (KR); Youn-Jin CHO, Suwon-si (KR)

(21) Appl. No.: 14/488,440

(22) Filed: Sep. 17, 2014

(30) Foreign Application Priority Data
Oct. 1, 2013 (KR) 10-2013-0117498
Aug. 25, 2014 (KR) 10-2014-0110915

(51) Int. Cl. C09D 183/16; C01B 33/12; B05D 3/02

(52) U.S. Cl. CPC C09D 183/16; B05D 3/0254; C01B 33/126
USPC 428/156; 427/379; 423/335; 524/869

(57) ABSTRACT

A composition for a silica based layer, a silica based layer, and a method of manufacturing a silica based layer, the composition including a solvent; and a silicon-containing polymer, the silicon-containing polymer having a weight average molecular weight of about 20,000 to about 160,000.

### CROSS-REFERENCE TO RELATED APPLICATION

Korean Patent Application No. 10-2013-0117498 filed on Oct. 1, 2013, and No, 10-2014-0110915 filed on Aug. 25, 2014, respectively, in the Korean Intellectual Property Office, and entitled: “Composition For Forming Silica Based Layer, Silica Based Layer And Method For Manufacturing Silica Based Layer,” are incorporated by reference herein in their entirety.

### BACKGROUND

1. Field

Embodiments relate to a composition for a silica based layer, a silica based layer, and a method of manufacturing a silica based layer.

2. Description of the Related Art

Due to accelerating development of semiconductor technologies, a highly-integrated and high-speed semiconductor memory cell having improved performance by increasing integration of a semiconductor chip having a smaller size has been considered.

### SUMMARY

Embodiments are directed to a composition for a silica based layer, a silica based layer, and a method of manufacturing a silica based layer.

The embodiments may be realized by providing a composition for a silica based layer the composition including a solvent; and a silicon-containing polymer, the silicon-containing polymer having a weight average molecular weight of about 20,000 to about 160,000.

The silicon-containing polymer may include a polysilazane, a polysiloxazane, or a combination thereof.

The silicon-containing polymer may have a weight average molecular weight of about 21,000 to about 50,000.

The silicon-containing polymer may have a number average molecular weight of about 4,000 to about 10,000.

The solvent may include at least one of benzene, toluene, xylene, ethylbenzene, diethylbenzene, trimethylbenzene, triethylbenzene, cyclohexane, cyclohexene, decahydro naphthalene, dipentene, pentane, hexane, heptane, octane, nonane, decane, ethylcyclohexane, methylcyclohexane, cyclohexane, cyclohexene, p-menthane, dipropylether, dibutylether, anisole, butyl acetate, amyl acetate, or methylisobutylketone.

The silicon-containing polymer may be included in an amount of about 0.1 to about 30 wt %, based on a total weight of the composition for a silica based layer.

The silicon-containing polymer may include a hydrogenated polysiloxazane or a hydrogenated polysilazane.

The hydrogenated polysiloxazane may have an oxygen content of about 0.2 wt % to about 3 wt %, based on 100 wt % of the hydrogenated polysiloxazane or the hydrogenated polysilazane, and a —SiH₃ group content of about 15% to about 40%, based on a total amount of a Si—H bond in the hydrogenated polysiloxazane or the hydrogenated polysilazane.

The embodiments may be realized by providing a silica based layer manufactured using the composition for a silica based layer according to an embodiment.

The silica based layer may have thickness variation of less than or equal to about 1.0.

The silica based layer may have a compactness of an internal oxide layer of greater than or equal to about 0.5 in a pattern of less than or equal to about 200 nm.

The embodiments may be realized by providing a method of manufacturing a silica based layer, the method including coating the composition for a silica based layer according to an embodiment on a substrate; drying the substrate that has been coated with the composition for a silica based layer; and curing the substrate under an atmosphere including water at greater than or equal to about 150° C.

### BRIEF DESCRIPTION OF THE DRAWING

Features will be apparent to those of skill in the art by describing in detail exemplary embodiments with reference to the attached drawing in which:

FIG. 1 illustrates a plan view of wafer for measuring thickness uniformity of silica based layers.

### DETAILED DESCRIPTION

Example embodiments will now be described more fully hereinafter with reference to the accompanying drawing; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figure, the dimensions of layers and regions may be exaggerated for clarity of illustration.

As used herein, when a definition is not otherwise provided, the term ‘substituted’ may refer to one substituted with a substituent selected from a halogen atom (F, Br, Cl, or I), a hydroxy group, an alkoxy group, a nitro group, a cyano group, an amino group, an azido group, an amidino group, a hydrazino group, a hydrazono group, a carbonyl group, a carbamyl group, a thiol group, an ester group, a carboxyl group or a salt thereof, a sulfonic acid group or a salt thereof, phosphoric acid or a salt thereof, alkyl group, a C2 to C16 alkenyl group, a C2 to C16 alkynyl group, an aryl group, a C7 to C13 arylalkyl group, a C1 to C4 oxyalkyl group, a C1 to C20 heteroalkyl group, a C3 to C20 heteroarylalkyl group, a cycloalkyl group, a C3 to C15 cycloalkenyl group, a C6 to C 15 cycloalkynyl group, a heterocycloalkyl group, and a combination thereof, instead of hydrogen of a compound.

Hereinafter, a composition for a silica based layer according to an embodiment is described.

A composition for a silica based layer according to an embodiment may include a silicon-containing polymer and a solvent. The silicon-containing polymer may include a polymer including a silicon (Si) atom e.g., a polysilazane, a polysiloxazane, or a combination thereof. The silicon-containing polymer may have a weight average molecular weight of, e.g., about 20,000 to about 160,000.

When the weight average molecular weight is within the range, thickness uniformity deterioration may not only be minimized (e.g., thickness variation may be minimized), but compactness inside a gap may also be increased, which may help minimize a defect inside the layer.

In an implementation, the silicon-containing polymer may have a weight average molecular weight of, e.g., about 21,000 to about 50,000 or about 20,000 to about 46,000.

The silicon-containing polymer may have a number average molecular weight of, e.g., about 4,000 to about 10,000, or about 4,000 to about 9,000.

When the number average molecular weight is within the range, thickness uniformity deterioration may not only be minimized (e.g., thickness variation may be minimized), but compactness inside a gap may also be increased, which may help minimize a defect inside the layer.

In an implementation, the silicon-containing polymer may include a hydrogenated polysiloxazane or a hydrogenated polysilazane.

The hydrogenated polysiloxazane may have an oxygen content of, e.g., about 0.2 wt % to about 3 wt %, based on 100 wt % of the hydrogenated polysiloxazane or the hydrogenated polysilazane.

When the oxygen content of the hydrogenated polysiloxazane is within the above-described range, contraction during heat treatment and a resultant crack on a charge pattern formed through the heat treatment may be reduced and/or prevented. In an implementation, the oxygen content of the hydrogenated polysiloxazane or the hydrogenated polysilazane may be, e.g., about 0.4 to about 2 wt %.

The hydrogenated polysiloxazane or the hydrogenated polysilazane may have a part or moiety represented by —SiH₃ at an end thereof. The —SiH₃ may be included in the hydrogenated polysiloxazane or the hydrogenated polysilazane in an amount of about 15 to about 40%, based on a total amount of a Si—H bond in the hydrogenated polysiloxazane or the hydrogenated polysilazane.

The hydrogenated polysiloxazane or the hydrogenated polysilazane may be included in the composition in an amount of, e.g., about 0.1 to about 30 wt %, based on a total weight of a composition for a silica based layer. When the hydrogenated polysiloxazane or the hydrogenated polysilazane are included within the range, a layer may be formed to be flat and uniform without a gap (e.g., a void) during gap-fill, and may maintain appropriate viscosity.

The solvent may include, e.g., an aromatic compound, an aliphatic compound, a saturated hydrocarbon compound, an ether, an ester, a ketone, or the like. In an implementation, the solvent may include, e.g., benzene, toluene, xylene, ethylbenzene, diethylbenzene, trimethylbenzene, triethylbenzene, cyclohexane, cyclohexene, decahydro naphthalene, dipentene, pentane, hexane, heptane, octane, nonane, decane, ethylcyclohexane, methylcyclohexane, cyclohexane, cyclohexene, p-menthane, dipropylether, dibutylether, anisole, butyl acetate, amyl acetate, methylisobutylketone, or a combination thereof.

In an implementation, at least one solvent in the composition may have a boiling point of greater than or equal to about 130° C. In this way, flatness of the layer may be increased.

The solvent may be included in a balance amount, except for the aforementioned components, based on the total weight of the composition for a silica based layer.

The composition for a silica based layer may further include a thermal acid generator (TAG).

The thermal acid generator may include a suitable compound that generates acid (H⁺) by heat. For example, the TAG may include a compound that is activated at about 90° C. or higher and that generates sufficient acid and also, that has low volatility. The thermal acid generator may include, e.g., nitrobenzyl tosylate, nitrobenzyl benzenesulfonate, phenol sulfonate, or a combination thereof.

The thermal acid generator may be included in an amount of about 0.01 to about 25 wt %, based on a total weight of the composition for a silica based layer.

The composition for a silica based layer may further include a surfactant.

The surfactant may include, e.g., a non-ionic surfactant such as polyoxyethylene alkyl ethers such as polyoxyethylene lauryl ether, polyoxyethylene stearyl ether, polyoxyethylene cetyl ether, polyoxyethylene oleyl ether, and the like, polyoxyethylene alkylallyl ethers such as polyoxyethylenenonyl phenol ether, and the like, polyoxyethylene•polyoxypropylene block copolymers, polyoxyethylene sorbitan fatty acid ester such as sorbitan monolaurate, sorbitan monopalmitate, sorbitan monostearate, sorbitan monoleate, polyoxyethylene sorbitan monostearate, polyoxyethylene sorbitan trioleate, polyoxyethylene sorbitan tristearate, and the like; a fluorine-based surfactant of EFTOP EF301, EF303, EF352 (Tochem Products Co., Ltd.), MEGAFACE F171, F173 (Dainippon Ink & Chem., Inc.), FLUORAD FC430, FC431 (Sumitomo 3M), Asahi guardAG710, SurfIon S-382, SC101, SC102, SC103, SC104, SC105, SC106 (Asahi Glass Co., Ltd.), and the like; other silicone-based surfactant such as a organosiloxane polymer KP341 (Shin-Etsu Chemical Co., Ltd.), or the like.

The surfactant may be included in an amount of about 0.001 to about 10 wt %, based on the total weight of the composition for a silica based layer. Within the range, dispersion of a solution and simultaneously, uniform thickness of a layer and filling properties, may be improved.

According to another embodiment, a silica based layer manufactured using the composition for a silica based layer may be provided.

The silica based layer may be used, e.g., as an insulation layer in an electronic device such as a semiconductor, a display device, or the like. The insulation layer may be used, e.g., between a transistor device and a bit line, between the transistor device and a capacitor, or the like.

The silica based layer may have a thickness variation of less than or equal to about 1.0. When the thickness variation is within the range, the silica based layer may have excellent uniformity, and thus, a subsequent process after forming the silica based layer may be easily conducted. Thickness variation of the silica based layer may be obtained according to the following equation.

*Thickness Variation=[(Maximum Thickness−Minimum Thickness)/2/Average Thickness]*100

In an implementation, the silica based layer may have compactness of an internal oxide layer of greater than or equal to about 0.5 in a pattern of less than or equal to about 200 nm. The silica based layer may have a high compactness inside a gap when the compactness of the internal oxide layer is within the range. The high compactness of the internal oxide layer may be obtained according to the following formula.

*Compactness of internal oxide layer=External surface etching amount/etching amount inside pattern

Another embodiment may include a method for manufacturing a silica based layer.

The method for manufacturing a silica based layer may include coating the composition for a silica based layer on a substrate; drying the substrate (that has been coated with the composition for a silica based layer); and curing the substrate (under an atmosphere including moisture or water at a temperature of greater than or equal to about 150° C.).

The composition for a silica based layer may be a solution obtained by mixing the silicon-containing polymer with the solvent and/or coating, e.g., through a solution process such as spin-coating, slit-coating, screen-printing, inkjet, ODF (one drop filling), or a combination thereof.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

Preparation of Composition for Silica Based Layer

### COMPARATIVE EXAMPLE 1

Dry nitrogen was substituted in a 2 L-reactor having an agitating device and a temperature controller. Subsequently, 1,500 g of dry pyridine was injected into the reactor, and the reactor was stored at 5° C. Then, 140 g of dichlorosilane was slowly injected thereinto for 2 hours. Then, 85 g of ammonia was slowly injected for 4.3 hours, while the mixture was agitated. Then, dry nitrogen was injected into the reactor for 120 minutes, and ammonia remaining therein was removed.

The obtained white slurry product was filtered with a 1 μm TEFLON (tetrafluoroethylene) filter under a dry nitrogen atmosphere, obtaining 1,000 g of a filtered solution. Subsequently, 1,000 g of dry xylene was added thereto, and the mixture was adjusted to have 20% of a solid concentration by substituting the xylene with pyridine three times with a rotary evaporator and then, filtered with a TEFLON filter having a pore size of 0.1 μm to obtain a hydrogenated polysilazane solution.

250 g of dry pyridine was added to the obtained hydrogenated polysilazane solution, and the mixture was polymerized at 100° C. to have a weight average molecular weight of 4,000 (number average molecular weight=2,270) .

Weight average molecular weights and number average molecular weights were measured by using GPC (PLC Pump 1515, RI Detector 2414) made by Waters and a column (LF-804) made by Shodex.

### COMPARATIVE EXAMPLE 2

Dry nitrogen was substituted in a 2 L reactor having an agitating device and a temperature controller. Subsequently, 1,500 g of dry pyridine was injected in the reactor, and the reactor was stored at 5° C. Then, 140 g of dichlorosilane was slowly injected thereinto for 2 hours. Then, 85 g of ammonia was slowly injected thereinto while the reactor was agitated for 4.3 hours. Then, dry nitrogen was injected thereinto for 120 minutes, and the ammonia remaining in the reactor was removed.

The obtained white slurry product was filtered with a 1 μm TEFLON filter under a dry nitrogen atmosphere, obtaining 1,000 g of a filtered solution. Subsequently, 1,000 g of dry xylene was added thereto, and the mixture was adjusted to have 20% of a solid concentration by substituting the xylene with pyridine three times with a rotary evaporator to adjust and then, filtered with a TEFLON filter having a pore size of 0.1 μm to obtain a hydrogenated polysilazane solution.

Then, 250 g of dry pyridine was added to the hydrogenated polysilazane solution, and the mixture was polymerized at 100° C. to have a weight average molecular weight of 14,000(number average molecular weight=3,750).

### COMPARATIVE EXAMPLE 3

Dry nitrogen was substituted in a 2 L reactor having an agitating device and a temperature controller. Subsequently, 1,500 g of dry pyridine was injected into the reactor, and the reactor was stored at 5° C. Then, 140 g of dichiorosilane was slowly injected thereinto for 2 hours. Then, 85 g of ammonia was slowly injected thereinto for 4.3 hours, while the mixture was agitated. Then, dry nitrogen was injected thereinto for 120 minutes, and the ammonia remaining in the reactor was removed.

The obtained white slurry product was filtered with a 1 μm Teflon filter under a dry nitrogen atmosphere, obtaining 1,000 g of a filtered solution. Subsequently, 1,000 g of dry xylene was added thereto, and the mixture was adjusted to have a solid concentration of 20% by substituting the xylene with pyridine three times with a rotary evaporator and then, filtered with a TEFLON filter having a pore size of 0.1 μm to obtain a hydrogenated polysilazane solution.

Then, 250 g of dry pyridine was added to the hydrogenated polysilazane solution, and the mixture was polymerized at 100° C. to have a weight average molecular weight of 19,000(number average molecular weight=3,950).

### COMPARATIVE EXAMPLE 4

Dry nitrogen was substituted in a 2 L reactor having an agitating device and a temperature controller. Subsequently, 1,500 g of dry pyridine was injected into the reactor, and the reactor was stored at 5° C. Then, 140 g of dichlorosilane was slowly injected thereinto for 2 hours. Then, 85 g of ammonia was slowly injected thereinto for 4.3 hours, while the mixture was agitated. Then, dry nitrogen was injected thereinto for 120 minutes, and the ammonia remaining in the reactor was removed.

The obtained white slurry product was filtered with a 1 μm TEFLON filter under a dry nitrogen atmosphere, obtaining 1,000 g of a filtered solution. Subsequently, 1,000 g of dry xylene was added thereto, and the mixture was adjusted to have a solid concentration of 20% by substituting the xylene with pyridine three times with a rotary evaporator and then, filtered with a TEFLON filter having a pore size of 0.1 μm to obtain a hydrogenated polysilazane solution.

Then, 250 g of dry pyridine was added to the hydrogenated polysilazane solution, and the mixture was polymerized at 100° C. to have a weight average molecular weight of 161,000(number average molecular weight=9,050).

### EXAMPLE 1

Dry nitrogen was substituted in a 2 L reactor having an agitating device and a temperature controller. Subsequently, 1,500 g of dry pyridine was injected into the reactor, and the reactor was stored at 5° C. Then, 140 g of dichlorosilane was slowly injected thereinto for 2 hours. Then, 85 g of ammonia was slowly injected thereinto for 4.3 hours while the mixture was agitated. Then, dry nitrogen was injected thereinto for 120 minutes, and the ammonia remaining therein was removed.

The obtained white slurry product was filtered with a 1 μm TEFLON filter under a dry nitrogen atmosphere, obtaining 1,000 g of a filtered solution. Subsequently, 1,000 g of dry xylene was added thereto, and the mixture was adjusted to have a solid concentration of 20% by substituting the xylene with pyridine three times with a rotary evaporator and then, filtered with a TEFLON filter having a pore size of 0.1 μm to obtain a hydrogenated polysilazane solution.

Then, 250 g of dry pyridine was added to the obtained hydrogenated polysilazane solution, and the mixture was polymerized at 100° C. to have a weight average molecular weight of 21,000(number average molecular weight=4,050).

### EXAMPLE 2

Dry nitrogen was substituted in a 2 L reactor having an agitating device and a temperature controller. Subsequently, 1,500 g of dry pyridine was injected into the reactor, and the reactor was stored at 5° C. Then, 140 g of dichlorosilane was slowly injected thereinto for 2 hours. Then, 85 g of ammonia was slowly injected thereinto for 4.3 hours, while the mixture was agitated. Then, dry nitrogen was injected thereinto for 120 minutes, and the ammonia remaining in the reactor was removed.

The obtained white slurry product was filtered with a 1 μm TEFLON filter under a dry nitrogen atmosphere, obtaining 1,000 g of a filtered solution. Subsequently, 1,000 g of dry xylene was added thereto, and the mixture was adjusted to have a solid concentration of 20% by substituting the xylene with pyridine three times with a rotary evaporator and then, filtered by using a TEFLON filter having a pore size of 0.1 μm to obtain a hydrogenated polysilazane solution.

Then, 250 g of dry pyridine was added to the obtained hydrogenated polysilazane solution, and the mixture was polymerized at 100° C. to have a weight average molecular weight of 68,000(number average molecular weight=5,750).

### EXAMPLE 3

Dry nitrogen was substituted in a 2 L reactor having an agitating device and a temperature controller. Subsequently, 1,500 g of dry pyridine was injected into the reactor, and the reactor was stored at 5° C. Then, 140 g of dichlorosilane was slowly injected thereinto for 2 hours. Then, 85 g of ammonia was slowly injected thereinto for 4.3 hours while the mixture was agitated. Then, dry nitrogen was injected thereinto for 120 minutes, and the ammonia remaining in the reactor was removed.

The obtained white slurry product was filtered with a 1 μm TEFLON filter under a dry nitrogen atmosphere, obtaining 1,000 g of a filtered solution. Subsequently, 1,000 g of dry xylene was added thereto, and the mixture was adjusted to have a solid concentration of 20% by substituting the xylene with pyridine three times with a rotary evaporator and then, filtered with a TEFLON filter having a pore size of 0.1 μm to obtain a hydrogenated polysilazane solution.

Then, 250 g of dry pyridine was added to the obtained hydrogenated polysilazane solution, and the mixture was polymerized at 100° C. to have a weight average molecular weight of 115,000(number average molecular weight=7,400).

### EXAMPLE 4

Dry nitrogen was substituted in a 2 L reactor having an agitating device and a temperature controller. Subsequently, 1,500 g of dry pyridine was injected into the reactor, and the reactor was stored at 5° C. Then, 140 g of dichlorosilane was slowly injected thereinto for 2 hours. Then, 85 g of ammonia was slowly injected for 4.3 hours while the mixture was agitated. Then, dry nitrogen was injected for 120 minutes, and the ammonia remaining in the reactor was removed.

The obtained white slurry product was filtered with a 1 μm TEFLON filter under a dry nitrogen atmosphere, obtaining 1,000 g of a filtered solution. Subsequently, 1,000 g of dry xylene was added thereto, and the mixture was adjusted to have a solid concentration of 20% by substituting the xylene with pyridine three times with a rotary evaporator and then, filtered with a TEFLON filter having a pore size of 0.1 μm to obtain a hydrogenated polysilazane solution.

Then, 250 g of dry pyridine was added to the obtained hydrogenated polysilazane solution, and the mixture was polymerized at 100° C. to have a weight average molecular weight of 155,000(number average molecular weight=8,800).

Evaluation 1: Layer Thickness Uniformity

3 cc of the hydrogenated polysilazane or the hydrogenated polysiloxazane solutions according to Example 1-4 and Comparative Example 1-4 were dispensed with a spin coater in the center of a silicon wafer having a diameter of 8 inches and spin-coated at 1,500 rpm for 20 seconds (MS-A200, MIKASA Co., Ltd.). Subsequently, the coated wafers were heated at 150° C. for 3 minutes on a hot plate and dried, forming a hydrogenated polysiloxazane or the hydrogenated polysiloxazane layer.

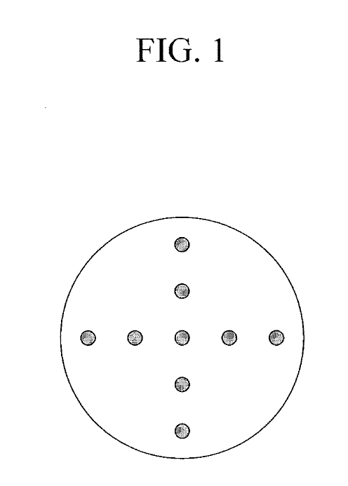

Then, average thickness, thickness range (a minimum thickness−a maximum thickness), and thickness variation of the hydrogenated polysiloxazane layers were obtained by measuring thickness of the hydrogenated polysiloxazane layers at 9 points on the wafer with a shape of a cross (+) by using a reflection spetroscopic layer thickness meter (ST-5000, K-MAC) as shown in FIG. 1,

*Thickness Variation=[(Maximum Thickness−Minimum Thickness)/2/Average Thickness]*100

The results are provided in the following Table 1.

TABLE 1

| | Average thickness | Thickness | Thickness |
|---|---|---|---|
| | (Å) | Range (Å) | variation |
| Comparative Example 1 | 5954 | 167 | 1.4 |
| Comparative Example 2 | 5961 | 145 | 1.2 |
| Comparative Example 3 | 5950 | 132 | 1.1 |
| Comparative Example 4 | 5958 | 58 | 0.5 |
| Example 1 | 5949 | 110 | 0.9 |
| Example 2 | 5952 | 104 | 0.9 |
| Example 3 | 5964 | 87 | 0.7 |
| Example 4 | 5951 | 75 | 0.6 |

Referring to Table 1, Examples 1 to 4 and Comparative Example 4 showed relatively smaller layer thickness variation than Comparative Examples 1 to 3. For example, a silica based layer formed by using a hydrogenated polysilazane or a hydrogenated polysiloxazane solution having a weight average molecular weight greater than or equal to 20,000 (according to Examples 1 to 4 and Comparative Example 4) showed a relatively uniform thickness.

Evaluation 2: Compactness of Internal Oxide Layer Inside Gap

The hydrogenated polysilazane solutions according to Example 1-4 and Comparative Example 1-4 were spin-coated on a 3 cm×3 cm size patterned wafer (MS-A200, MIKASA Co., Ltd.). Subsequently, the coated wafers were soft-baked for 3 minutes at 150° C. Then, the layers were oxidized through a high temperature oxidation reaction at 800° C. and then, dipped in an aqueous solution (DHF) obtained by mixing fluoric acid and ammonium fluoride (100:1) for 5 minutes. Then, a pattern was etched, and an etching amount inside a gap formed along the pattern was calculated through trigonometry (S-5500, Hitachi Ltd.). In addition, the hydrogenated polysilazane solutions were spin-coated on a bare wafer for 3 minutes at 150° C. in the same method as aforementioned and then, soft-baked. Then, an external etching amount was calculated by measuring a thickness of the layers after oxidization through a high temperature reaction at 800° C. and then, surface thickness of the layers etched by dipping the layer in an aqueous solution (DHF) obtained by mixing fluoric acid and ammonium fluoride (100:1) for 5 minutes with a reflection spectroscopic layer thinness meter (ST-5000, K-MAC Ltd.), and a compactness of an internal oxide layer was calculated based on the external etching amount.

*Compactness of internal oxide layer=External surface etching amount/Etching amount inside pattern

The results are provided in the following Table 2.

TABLE 2

| | Compactness of internal oxide layer | | |
|---|---|---|---|
| | pattern size | pattern size | pattern size |
| | 40 nm | 100 nm | 200 nm |
| Comparative Example 1 | 0.35 | 0.35 | 0.33 |
| Comparative Example 2 | 0.44 | 0.43 | 0.44 |
| Comparative Example 3 | 0.49 | 0.47 | 0.48 |
| Comparative Example 4 | pattern | pattern | pattern |
| | filling | filling | filling |
| | failure | failure | failure |
| Example 1 | 0.51 | 0.51 | 0.50 |
| Example 2 | 0.52 | 0.52 | 0.51 |
| Example 3 | 0.54 | 0.53 | 0.52 |
| Example 4 | 0.55 | 0.54 | 0.55 |

Referring to Table 2, the layers formed of the compositions according to Examples 1 to 4 exhibited excellent layer compactness inside a gap in all the patterns of less than or equal to 200 nm, compared with the layers of the composition according to Comparative Examples 1 to 3. In addition, a high compactness of a hydrogenated polysilazane or the hydrogenated polysiloxazane solution having a weight average molecular weight out of the range like Comparative Example 4 could not be measured, since the layer was not filled inside a gap.

By way of summation and review, requirements of high integration of a semiconductor may narrow a distance among wires and thus, may bring about a RC delay, a cross-talk, deterioration of a response speed, and the like, which may have an effect in terms of interconnection of the semiconductor. In addition, as for a dynamic random access memory (DRAM) including a plurality of a unit cell including one MOS transistor and one capacitor among semiconductor memory cells, the capacitor may include a dielectric layer positioned between two electrodes, the amount of the capacitor may be determined depending on a dielectric constant, a thickness of the dielectric layer, and an area of an electrode forming the capacitor, and accordingly, a capacitor capable of securing a storage capacity as the capacitor becomes smaller according as a semiconductor chip becomes smaller has been considered. This capacitor may be realized by increasing a vertical area instead of decreasing a horizontal area to increase an overall effective area. When this method is used to manufacture the capacitor, a silica layer formed by using a mold and filling a gap on the mold with a composition for forming the silica layer may be used to effectively form relatively higher electrodes than narrow horizontal area. Accordingly, a semiconductor insulation layer material capable of securing a thickness uniformity and a high compactness inside a gap may be desirable.

The embodiments may provide a composition for a silica based layer capable of securing a good thickness uniformity and a high compactness inside a gap.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A composition for a silica based layer, the composition comprising:
a solvent; and
a silicon-containing polymer, the silicon-containing polymer having a weight average molecular weight of about 20,000 to about 160,000.

2. The composition for a silica based layer as claimed in claim 1, wherein the silicon-containing polymer includes a polysilazane, a polysiloxazane, or a combination thereof.

3. The composition for a silica based layer as claimed in claim 1, wherein the silicon-containing polymer has a weight average molecular weight of about 21,000 to about 50,000.

4. The composition for a silica based layer as claimed in claim 1, wherein the silicon-containing polymer has a number average molecular weight of about 4,000 to about 10,000.

5. The composition for a silica based layer as claimed in claim 1, wherein the solvent includes at least one of benzene, toluene, xylene, ethylbenzene, diethylbenzene, trimethylbenzene, triethylbenzene, cyclohexane, cyclohexene, decahydro naphthalene, dipentene, pentane, hexane, heptane, octane, nonane, decane, ethylcyclohexane, methylcyclohexane, cyclohexane, cyclohexene, p-menthane, dipropylether, dibutylether, anisole, butyl acetate, amyl acetate, or methylisobutylketone.

6. The composition for a silica based layer as claimed in claim 1, wherein the silicon-containing polymer is included in an amount of about 0.1 to about 30 wt %, based on a total weight of the composition for a silica based layer.

7. The composition for a silica based layer as claimed in claim 1, wherein the silicon-containing polymer includes a hydrogenated polysiloxazane or a hydrogenated polysilazane.

8. The composition for a silica based layer as claimed in claim 7, wherein the hydrogenated polysiloxazane or the hydrogenated polysilazane have:
an oxygen content of about 0.2 wt % to about 3 wt %, based on 100 wt % of the hydrogenated polysiloxazane or the hydrogenated polysilazane, and
a —SiH₃ group content of about 15% to about 40%, based on a total amount of a Si—H bond in the hydrogenated polysiloxazane or the hydrogenated polysilazane.

9. A silica based layer manufactured using the composition for a silica based layer as claimed in claim 1.

10. The silica based layer as claimed in claim 9, wherein the silica based layer has thickness variation of less than or equal to about 1.0.

11. The silica based layer as claimed in claim 9, wherein the silica based layer has a compactness of an internal oxide layer of greater than or equal to about 0.5 in a pattern of less than or equal to about 200 nm.

12. A method of manufacturing a silica based layer, the method comprising
coating the composition for a silica based layer as claimed in claim 1 on a substrate;
drying the substrate that has been coated with the composition for a silica based layer; and
curing the substrate under an atmosphere including water at greater than or equal to about 150° C.
